(19) United States
(12) Patent Application Publication
(10) Pub. No.: US 2024/0091732 A1
(43) Pub. Date: Mar. 21, 2024

(54) PHOTOREACTOR FOR PHOTOCATALYSIS, RELATED SYSTEMS, AND RELATED METHODS

(71) Applicant: REGENTS OF THE UNIVERSITY OF MICHIGAN, Ann Arbor, MI (US)

(72) Inventors: Rachel Cassidy Elias, Ann Arbor, MI (US); Suljo Linic, Ann Arbor, MI (US)

(21) Appl. No.: 18/370,517

(22) Filed: Sep. 20, 2023

Related U.S. Application Data
(60) Provisional application No. 63/408,223, filed on Sep. 20, 2022.

(51) Int. Cl. B01J 19/12; B01J 19/00

(52) U.S. Cl. CPC B01J 19/12; B01J 19/0013; B01J 2219/00058; B01J 2219/00711; B01J 2219/00934; B01J 2219/00961; B01J 2219/0254; B01J 2219/0871; B01J 2219/0875; B01J 2219/0877; B01J 2219/1923; B01J 2219/1943

(57) ABSTRACT

The disclosure relates to a photoreactor for performing photocatalytic reactions with a particulate photocatalyst loaded in the reactor. The photoreactor includes an internal wall having an outer surface and defining an interior volume, and a transparent external wall having an outer surface and an opposing inner surface. The internal and external walls are spaced apart so that they together define a reaction volume between the walls. The photoreactor further includes an external light transmission apparatus, such as a light source and/or a light guide, positioned around the external wall and being adapted to transmit light through the external and into the reaction volume. When a particulate photocatalyst loaded in the reaction volume is irradiated by external light transmission apparatus while a reactant is flowing through the reaction volume, a photocatalytic reaction can be performed to form a desired reaction product.

### CROSS REFERENCE TO RELATED APPLICATION

Priority is claimed to U.S. Provisional Application No. 63/408,223 (filed Sep. 20, 2022), which is incorporated herein by reference in its entirety.

### STATEMENT OF GOVERNMENT INTEREST

This invention was made with government support under 1800197 awarded by the National Science Foundation. The government has certain rights in the invention.

### BACKGROUND OF THE DISCLOSURE

### Field of the Disclosure

The disclosure relates to a photoreactor for performing photocatalytic reactions with a particulate photocatalyst loaded in the reactor. The photoreactor includes an internal wall and a transparent external wall that are spaced apart so that they together define a reaction volume therebetween. The photoreactor further includes an external light transmission apparatus that is adapted to irradiate/illuminate the reaction volume, thereby activating any particulate photocatalyst therein.

### Brief Description of Related Technology

Photoreactors offer potential in industrially solar-driven air and wastewater treatment, water splitting, biomass conversion, and other chemical processes. To date, most lab-scale photoreactor designs for gas-phase chemistry consist of conventional tubular, annular, packed-bed, slurry, honeycomb monolith, or fluidized bed designs. Although annular photoreactors have been used in the past, most (but not all) of these seem to be designed for liquid-phase chemistry and are illuminated internally rather than externally. Annular photoreactors used for gas-phase chemistry with a solid-phase photocatalyst often rely on coating the tube itself with a thin layer of the catalyst material, rather than loading the full annular region with larger quantities of a catalyst powder sample.

A Harrick photoreactor includes a chamber that is a stainless-steel device with a small sample cup used to hold catalyst or other solid samples. The chamber is equipped with a quartz window which can be used to illuminate the top layer of catalyst in the sample cup. Some of the issues associated with this chamber include a very limited reactor loading volume (i.e., what can fit in the cup), susceptibility to contamination, lack of serviceability/cleaning options, non-ideal gas flow patterns, limitations to volume of catalyst that can be loaded into the reactor, and the inability to accurately control and measure catalyst temperature. The Harrick chamber also has mass transfer limitations limiting its effectiveness as a photoreactor. For example, one issue with the Harrick chamber is maximum loading capacity of <0.5 cm² of catalyst in the reactor. This becomes problematic when studying kinetic trends in the catalytic activity. For example, performing catalyst dilutions and increasing the size of the fixed bed (common techniques used when checking for mass transfer limitations), is often not possible in a reactor of fixed maximum loading volume. Moreover, the unsecured catalyst packing in the Harrick chamber sample cup sometimes results in “pockets” forming in the catalyst layer over the course of experimentation, especially when using higher flowrates, which can cause problems like channeling and inefficient gas contact with the catalyst bed.

Another problem with the Harrick chamber is the propensity for contamination buildup. The interior of the cell contains several components which are difficult to access due to the complex nature of the reactor's design. These areas are at risk to having dust from catalysts and other materials used in the reactor accumulate and deposit over time. Even very small amounts of residual catalyst or metal can be enough to drive chemical rates in the reactor, which our lab has observed to provide a source of misleadingly high catalytic rates in some reactions that are sensitive to specific metal contamination. For instance, one reactor contaminated with platinum catalyst has produced rates for platinum catalyzed reactions including CO oxidation and C₂H₄ hydrogenation, even when the reactor was cleaned and devoid of catalyst during a control experiment. The presence of the contaminating platinum was confirmed during a CO-FTIR study of the empty reactor, in which peaks corresponding to CO bound on Pt were observed. These same peaks were not observed in newer, non-contaminated reactors in our possession. Manual cleaning and sonication of the deconstructed reactor body with gentle solvents (e.g., 10% nitric acid) could not remove the contamination. Typically, residue from metal nanoparticles, catalysts, organics, and other associated support materials can be broken down or dissolved using a combination of acid blends including aqua regia (a fuming mixture of nitric acid and hydrochloric acid in a 1:3 molar ratio which dissolves metals including gold and platinum, among other metals) and/or Piranha solution (a mixture of sulfuric acid and hydrogen peroxide which dissolves organics), which effectively dissolve the problematic metals and other residual compounds. However, because the reactor is designed with 316 stainless-steel, it is impossible to use these acids without risk of dissolution or at minimum degradation of the stainless-steel reactor body. This reactor body is only able to sustain cleaning with low concentrations of nitric acid, which has proven ineffective in removing the bulk of material contributing to contamination.

Plasmonic metal nanoparticles (e.g., Ag, Au, and Cu) represent a class of materials that interact strongly with light via localized surface plasmon resonance (LSPR) excitation. LSPR is characterized by large optical extinction cross sections of the plasmonic metal nanoparticles and the generation of elevated electric fields, mainly confined to their surfaces. Over the past decade, it has been well-established that under conditions of LSPR, these nanomaterials can activate photocatalytic reactions due to their ability to harvest and redirect the supplied light energy to drive chemistry on their surfaces. Numerous studies have reported substantial reaction rate enhancements on illuminated plasmonic nanoparticle catalysts compared to corresponding rates under non-illuminated conditions. There are two mechanisms that have been proposed to explain the LSPR-induced chemical reactivity. One mechanism assumes a local plasmon-induced hot charge carrier mediated activation of the reactants, while the other assumes an LSPR-induced equilibrium heating of the catalyst, which leads to energy transfer to and chemical reaction of the adsorbed reactants.

A significant challenge in quantifying the relative importance of the different LSPR-induced rate enhancement mechanisms in part lies in the inherent difficulties in measuring and quantifying equilibrium photothermal heating under illumination in these catalysts. Accurately measuring the temperature of a catalyst under illumination is not trivial, since the catalyst is usually packed in a three-dimensional bed which is most often illuminated from one side, inducing significant temperature gradients in the bed. To measure the temperature of the catalyst bed, either a thermocouple or infrared (IR) camera is typically employed and both techniques pose some risk for inaccuracies. For instance, in the case of infrared measurements, it is necessary to have a reliable understanding of the catalyst's emissivity to obtain accurate surface temperature measurements. Unfortunately, due to the strong light-matter interactions that are highly sensitive to the catalyst (nanoparticle) geometry and concentration, it is difficult to accurately assess the emissivity of plasmonic nanoparticles packed in a three-dimensional catalyst bed. Furthermore, since IR cameras mainly probe the surface temperature of the catalyst—the region typically most impacted by illumination—these measurements are better suited for two-dimensional systems and may overestimate the average temperature in a three-dimensional catalyst bed. Measurements relying on thermocouples can also overestimate the temperature of the catalyst bed as many thermocouples respond to light illumination by temperature changes due to the optical excitations within the thermocouple materials. This is especially problematic when the thermocouple is not fully embedded in the catalyst layer and is exposed more directly to the light source. For instance, directly illuminating an OMEGA stainless steel sheathed K-type thermocouple (the same thermocouple we use in our catalyst temperature measurements) using a broadband visible light source with its peak intensity at 400 mW/cm² can lead to artificially inflated measured temperature by tens of degrees.

### SUMMARY

In one aspect, the disclosure relates to a photocatalytic photoreactor comprising: a first (or internal) wall (e.g., inner duct, tube, channel, conduit) having an outer surface and an opposing inner surface, the inner surface defining an interior volume (e.g., an open interior space for a heater, second light source, heat transfer liquid flow); a second (or external) wall (e.g., outer duct, tube, channel, conduit) having an outer surface and an opposing inner surface, the second wall being spaced apart from the first wall such that the first wall and the second wall together define a reaction volume between the first wall outer surface and the second wall inner surface; and an external light transmission apparatus (e.g., a light source and/or a light guide). The second wall is at least partially transparent, for example fully or partially transparent, such as being formed fully from a transparent material such as a glass, or being formed from a material having transparent sections where catalyst is to be loaded, etc. The reaction volume is sized and shaped to receive (e.g., and contain, retain, hold, etc.) a particulate photocatalyst therein such that incident light passing through the second wall from the second wall outer surface, to the second wall inner surface, and into the reaction volume penetrates a substantial portion of the reaction volume (e.g., thickness thereof) when a particulate photocatalyst is contained therein. The light transmission apparatus is positioned external to and at least partially around (e.g., fully or partially around the circumference of) the second wall outer surface (e.g., external to the reaction volume). Further, the light transmission apparatus is adapted to transmit light through the second wall from the second wall outer surface, to the second wall inner surface, and into the reaction volume (e.g., fully or partially around the circumference thereof).

Various refinements of the disclosed photoreactor are possible.

In a refinement, the reaction volume has a thickness in a range of 0.5 mm to 10 mm. The thickness of the reaction volume can be expressed as the distance between first wall outer surface and the second wall inner surface, for example in a direction (locally) perpendicular to one or both of the wall surfaces. For example, in a cylindrical photoreactor with an annular reaction volume, the reaction volume thickness can be expressed as the annular difference in radii for two concentric tubes forming the first and second walls. Similarly, in a duct or channel photoreactor with a rectangular (e.g., square) cross section, the reaction volume thickness can be expressed as the difference in channel half-widths for two coaxial channels forming the first and second walls.

More generally, the reaction volume thickness can be in a range of 0.5 mm to 10 mm or 1 mm to 3 mm, for example at least 0.1, 0.2, 0.3, 0.5, 0.7, 1, 1.2, 1.5, 2, or 2.5 mm and/or up to 1, 1.5, 2, 2.5, 3, 4, 5, 7, or 10 mm. The reaction volume thickness can be constant or variable along the length/axial direction (e.g., flow direction) of the photoreactor. The relatively small reaction volume thickness is selected such that incident light from the external light transmission apparatus is able to penetrate and illuminate a substantial portion of the reaction volume when it is filled with photocatalyst, thus providing the photocatalyst with the necessary light to induce its catalytic activity. As the reaction volume thickness increases, there is potentially a dead or inactive zone in the reaction volume (e.g., close to the first wall) where light does not penetrate and there is not substantial photocatalytic activity. In contrast to the photoreactor according to the disclosure, other annular photoreactors intended for homogeneous reactions have substantially larger reaction volume thicknesses, because incident light from the interior of such annular photoreactors can easily penetrate a larger/thicker (and typically clear) homogeneous reaction medium, which is in contrast to the heterogeneous reaction medium of the disclosed photoreactor.

In a refinement, the reaction volume has an elongate structure with a length (L)/thickness (T) ratio of at least 10. More generally, the photoreactor and its corresponding reaction volume can have any suitable length, where longer lengths (or higher aspect ratios L/T) provide longer residence time for reaction within the reaction volume. For example, the photoreactor and/or its corresponding reaction volume can have an aspect ratio L/T of at least 1, 2, 5, 10, 15, 20, or 30 and/or up to 10, 20, 30, 40, 50, 70, 100, 200, 300, 500, or 1000. In some embodiments, multiple photoreactors can be arranged in series to provide a desired total residence/reaction time. In some embodiments, multiple photoreactors can be arranged in parallel to provide a desired capacity or throughput for a given residence/reaction time.

In a refinement, the interior volume has a characteristic lateral dimension in a range of 5 mm to 100 mm. The lateral dimension of the interior volume can be the (inner) diameter of a corresponding cylindrical tube for the first wall, the (inner) width of a corresponding rectangular duct or conduit for the first wall, etc., and the lateral dimension is generally perpendicular to a longitudinal or axial direction defined by the first wall. More generally, the lateral dimension of the interior volume can be in a range of 1 mm to 100 mm, 5 mm to 100 mm or 8 mm to 20 mm, for example at least 1, 2, 3, 4, 5, 6, 7, 8, 10, 15, 20, or 30 mm and/or up to 10, 15, 20, 30, 40, 50, 70, or 100 mm.

In a refinement, incident light passing through the second wall from the second wall outer surface, to the second wall inner surface, and into the reaction volume penetrates at least 50% of the reaction volume (e.g., thickness thereof) when a particulate photocatalyst is contained therein. More generally, the photoreactor and its corresponding reaction volume can be sized and shaped such that at least 10, 20, 30, 40, 50, 60, 70, 80, or 90% and/or up to 60, 70, 80, 90, 95, or 100% of the reaction volume (e.g., the portion thereof closest to the second wall) is illuminated by incident light passing through the second wall from the second wall outer surface, to the second wall inner surface, and into the reaction volume. Higher illumination fractions can provide greater overall catalytic activity and conversion per unit reaction volume. Lower illumination fractions can be desirable in some cases, for example when it is desired to create light-induced temperature gradients within the reaction volume (e.g., where an exothermic or endothermic reaction creates a temperature gradient due to a localized reaction in the illuminated portion of the reaction volume). In embodiments where a second (internal) light source is located in the inner volume defined by the first wall (or tube), similar values can correspond to fractions of the reaction volume (e.g., the portion thereof closest to the first wall) that are illuminated by incident light passing through the first wall from the first wall inner surface, to the first wall outer surface, and into the reaction volume. In such cases, the two light sources can collectively illuminate the entire reaction volume from both sides.

In a refinement, the first wall is a first cylindrical tube; the second wall is a second cylindrical tube coaxially aligned with the first cylindrical tube; and the reaction volume is a (circular) annular volume between the first cylindrical tube and the second cylindrical tube (e.g., where the reaction volume thickness is ΔR for the two cylindrical tube radii). Other geometries with non-circular cross sections are possible, such as rectangular or square, oval or elliptical, etc. Circular cross sections with the corresponding annular reaction volume are convenient from a construction standpoint due to the use of cylindrical tubes, but other geometries can provide the same benefits in terms of reactor performance as the annular design.

In a refinement, the first wall is a first rectangular duct; the second wall is a second rectangular duct coaxially aligned with the first rectangular duct; and the reaction volume is a (rectangular or square) annular volume between the first rectangular duct and the second rectangular duct (e.g., where the reaction volume thickness is ΔW/2 for the two rectangular duct widths).

In a refinement, the light transmission apparatus comprises at least one light source, which is configured (e.g., positioned, adapted) to transmit light around the (entire) circumference of the second wall and into the reaction volume. The light source in general can be any known device or apparatus capable of generating and emitting light (or electromagnetic radiation) in or across one or more wavelengths. The light source can be any suitable lamp or light, for example an LED lamp. The light source can be selected so that it can emit light in one of more of the UV (e.g., 10-400 nm or 200-400 nm), visible (e.g., 380-750 nm, 380-800 nm, or 420-680 nm), and IR (e.g., 700 nm-1 mm) spectra, or at a wavelength or subset of wavelengths therein, depending the excitation wavelength(s) of the intended photocatalyst. The light source can be mounted on or adjacent to the second wall. The at least one light source can include multiple light sources, for example including an array of a plurality of lights distributed around the second wall, a sleeve or jacket containing light(s) therein to be mounted around the second wall, etc.

In a refinement, the light transmission apparatus comprises at least one light guide, which is configured (e.g., positioned, adapted) to transmit received light around the (entire) circumference of the second wall and into the reaction volume. The light guide can be any suitable optical device that receives light from an external source, for example a lamp or ambient sunlight, and then redirects the received light to a plurality positions around the photoreactor and into the reaction volume. Examples include optical fibers, a fiber optic light guide, an annular light guide, a solar collector, etc. The light guide can be mounted on or adjacent to the second wall.

In a refinement, the light transmission apparatus comprises at least one light source and at least one light guide, for example a light source mounted to a light guide, which is mounted to the second wall, such that the light guide distributes light from the light source into and around the reaction volume.

In a refinement, the interior volume defined by the first wall is an open interior volume adapted to receive one or more of (i) a heating apparatus adapted (or configured, positioned) to deliver thermal energy into the reaction volume through the first wall, (ii) a second light source adapted (or configured, positioned) to deliver light into the reaction volume through the first wall (when transparent), and (iii) a heat transfer liquid flowing through the open interior volume to heat or cool the reaction volume via heat transfer through the first wall.

In a refinement, the photoreactor further comprises a heating apparatus in the interior volume, the heating apparatus being adapted to deliver thermal energy into the reaction volume through the first wall.

In a refinement, the first wall is at least partially transparent (e.g., fully or partially transparent, such as being formed fully from a transparent material such as a glass, or being formed from a material having transparent sections where catalyst is to be loaded, etc.); and the photoreactor further comprises a second light source in the interior volume, the second light source being adapted to deliver light into the reaction volume through the first wall.

In a refinement, the second wall comprises (e.g., is formed from) quartz glass. More generally, the second (or external/outer) wall of the photoreactor can be formed from or otherwise include any suitable transparent material that permits transmission of light from the external light transmission apparatus into the reaction volume, and that has sufficient mechanical, physical, and chemical properties to withstand the reaction conditions within the photoreactor. Quartz glass is particularly useful because it has high transparency/transmittance across a wide range of light wavelengths, and it has high thermal resistance, making it suitable for high-temperature reaction conditions. Other suitable materials can include other glasses (e.g., borosilicate glasses), transparent plastic materials (e.g., acrylic glass), etc., for example when the photoreactor is intended for reactions under relatively mild conditions (e.g., low-P, low-T reaction conditions).

In a refinement, the first wall comprises (e.g., is formed from) quartz glass. More generally, the first (or internal/inner) wall of the photoreactor can be formed from or otherwise include the materials as described above for the second wall. For example, the first wall can include a transparent material when the interior volume is intended to include a second light source providing illumination to complement that of the external light source. In other embodiments, the first wall can be formed from or otherwise include a non-transparent material, for example a ceramic material such as alumina. Non-transparent materials are suitable when there is no intention to include a second light source in the interior volume. Non-transparent materials also can be selected based on their thermal conductivity to promote more efficient heat transfer, for example when the interior volume contains a heating element, a heat transfer fluid (e.g., gas or liquid), etc. While metal materials such as stainless steel can be used as the material for the first wall, metals are often preferably avoided because various photocatalytic reactions can easily contaminate metal surfaces with deposits. In contrast, such contamination is often avoided, limited, or otherwise reduced with quartz glass or ceramic surfaces, which are also relatively easier to clean or decontaminate as compared metals and other materials.

In a refinement, the first wall comprises an at least partially porous support (e.g., at the first wall inner surface) and a selectively permeable membrane adjacent (e.g., adhered or bound) to the porous support (e.g., at the first wall outer surface); and/or the second wall comprises an at least partially porous support (e.g., at the second wall outer surface) and a selectively permeable membrane adjacent (e.g., adhered or bound) to the porous support (e.g., at the second wall inner surface). In embodiments, one or both of the inner and outer walls can incorporate a selectively permeable membrane, for example being selectively permeable to one or more reaction products, but impermeable to other reaction product, reactants, reaction medium, etc. The inclusion of a membrane can facilitate separation and removal of a particular product as it is formed in the reaction volume during reaction, for example to provide a purified product stream, prevent reverse reactions from occurring, etc. For example, hydrogen (H₂)-permeable membranes are generally known in the art and can be used when the photoreactor is used to perform a photocatalytic water-splitting reaction. A water-splitting reaction can be performed to product both oxygen (O₂) and hydrogen (H₂) as desired products, but the reversible nature of the water-splitting reaction can lead to re-formation of water in the reaction volume, thus reducing overall conversion. Examples of suitable catalysts for water-splitting include Pt, NiMo, and/or Ru for hydrogen evolution, and Ir, Ni, and/or Co for oxygen evolution. The catalyst materials (e.g., a pair catalyst materials including one for hydrogen evolution and one for oxygen evolution) can be immobilized on or otherwise coupled to a light-absorbing semiconductor support (e.g., TiO₂) and/or a plasmonic component (e.g., Ag, Au, Cu, Al as described below) to absorb light and provide the photocatalyst. Accordingly, inclusion of a hydrogen-permeable membrane (i.e., which also is water- and oxygen-impermeable) allows hydrogen to be removed and recovered from the reaction volume as it is formed, thus preventing the reverse water-formation reaction and increasing the overall production of both oxygen and hydrogen products. Suitable hydrogen-permeable membranes include those based on silica, and these are relatively thin (e.g., on the order of hundreds of nanometers, such as at least 100, 200, or 300 nm and/or up to 500, 700, or 1000 nm) as well as transparent (i.e., making them suitable for use at inner or outer wall where light transmission is desired). Examples of suitable hydrogen-permeable membranes include commercially available sulfonated polytetrafluoroethylene membranes (e.g., NAFION-based proton-permeable membranes), perovskite- or other ceramic-based membranes that permeate molecular hydrogen or protons, etc.

Given the typically thin nature of selectively permeable membranes, they are generally used in combination with an at least partially porous support to provide structural integrity to the wall and membrane, but including sufficient open areas to allow fluid flow therethrough (e.g., species passing through the membrane can also pass through the porous support), and optionally to allow light transmission therethrough (e.g., when used for a transparent wall). The porous support can be fully or partially porous in the sense that the first or second wall can be fully formed from a porous support/membrane combination, or the first or second wall can include sections of the porous support/membrane combination where catalyst is to be loaded for the reaction volume. A suitable porous support can include a porous tube or duct, a mesh (e.g., stainless steel), etc. upon which the membrane is adhered or mounted, or two porous or mesh structures between which the membrane is sandwiched. Examples of suitable porous materials include porous alumina, porous quartz or glass, porous plastics (e.g., high-density polyethylene (HDPE)), for example in tube or duct form. Different porous materials can be selected based on their ability to withstand high-temperature conditions in view of a particular reaction to be performed in the photoreactor. The open areas of the of the porous support allow flow of the species transported across the membrane, and in some cases the porous support also allows for light transmission (e.g., a transparent support material, open areas in a mesh, etc.).

In a refinement, the photoreactor further comprises: a particulate photocatalyst contained in the reaction volume. The particulate photocatalyst can include a plurality of photocatalyst particles as a packing or filling in the reaction volume with sufficient void volume for fluid flow through the reaction volume and around/over the photocatalyst particles. The photoreactor can further include a means for retaining the photocatalyst within the reaction volume, which means can also be positioned within or adjacent to the reaction volume. For example, glass or quartz wool inserted into the gap between the inner and outer walls can be used to hold or secure the photocatalyst in the reaction volume. Such glass or quartz wool retaining means can be suitable for gas-phase reactions (e.g., a gaseous reaction medium fed to the reaction volume, where it passes over and through the wool and particulate photocatalyst therein). Alternatively, a mesh or porous support having higher structural integrity than glass wool, but with sufficient open areas to retain the photocatalyst while allowing fluid flow therethrough, can be used as a retaining means. Such mesh or porous retaining means can be suitable for gas-phase reactions or for liquid-phase reactions (e.g., a liquid reaction medium fed to the reaction volume, where it passes over and through the mesh/porous support and particulate photocatalyst therein).

Photocatalysts are generally known in the art and generally include materials capable of exhibiting catalytic activity upon the absorption of light (e.g., in general or of specific wavelength(s)), such as resulting from the formation of excited charge carriers, free radicals, etc. Plasmonic and hybrid plasmonic photocatalysts can include plasmonic metal nanoparticles, for example Ag, Au, Cu, Al, and combinations thereof, such as with other plasmonic metals or with other (catalytic) metals such as Pt, Pd, Ru, Rh, etc. Combinations of such metals can include alloys, core-shell structures (e.g., plasmonic metal core, other metal coating/shell), and decorated particulate structures (e.g., plasmonic metal larger particles with other smaller metal particles decorated on the surfaces thereof). Plasmonic metals interact with incident light via localized surface plasmon resonance (LSPR) to generate their catalytic activity. The light-induced catalytic activity can be mediated by excited charge carriers (charge transfer mechanism), elevated fields at the surfaces of the particles, or photothermal heating effects which can activate adsorbates (reactants) attached to the surfaces of the particles. These processes may work synergistically in plasmonic catalysts. Other photocatalyst materials can include semiconductor materials such as transition metal oxides and semiconductors, for example CeO₂, TiO₂, etc. The photocatalysts can further include a (catalytic or non-catalytic) support, for example alumina (Al₂O₃), silica (SiO₂), etc.

In a further refinement, the particulate photocatalyst comprises a plasmonic metal selected from the group consisting of silver (Ag), gold (Au), copper (Cu), and combinations thereof.

In a further refinement, the particulate photocatalyst has a particle size in a range of 100 μm to 500 μm or 0.005 μm to 500 μm. More generally, the particulate photocatalyst can have a particle size of at least 0.005, 0.01, 0.02, 0.05, 0.1, 0.2, 0.5, 1, 2, 5, 10, 20, 50, 100, or 200 μm and/or up to 0.05, 0.1, 0.2, 0.5, 1, 2, 5, 10, 20, 50, 100, 200, 300, 400, or 500 μm. The foregoing sizes and size ranges can represent average sizes (e.g., weight-, volume-, or number-averages) or size distributions (e.g., 1/99%, 5/95%, or 10/90% cut points of a cumulative size distribution based on weight, number, or volume) for the particles, for example where the size can represent an approximate or spherical-equivalent diameter of the particles. Additionally, the foregoing sizes can represent the size of the photocatalyst particle as a whole (e.g., including a support with smaller photocatalytic particles thereon).

In a refinement, the photoreactor further comprises: a particulate photocatalyst adhered to at least one of the first wall outer surface and the second wall inner surface. More generally, the particulate photocatalyst can be coated (e.g., as a discontinuous layer or discrete particles), bound, or otherwise immobilized on one or both of the interior photoreactor walls facing the reaction volume. Such adhered particulate photocatalyst can be in addition to or instead of the free particulate photocatalyst described above as generally loose packing or fill in the reaction volume. The adhered particulate photocatalyst can be the same as or different from the free particulate photocatalyst, and it generally can be selected from the same materials, sizes, etc. Common photocatalyst materials are relatively easy to deposit as particulates on such as quartz (e.g., roughened quartz, such as for the first and/or second wall), alumina (e.g., such as for the first wall), etc., making them easily adaptable for use with common materials used for the photoreactor walls.

In a refinement, the photoreactor further comprises: a thermocouple (or other temperature sensor) positioned within the reaction volume. The thermocouple can be positioned so that it is in contact with the particulate photocatalyst (when present) In some embodiments, the photoreactor can include multiple embedded or otherwise positioned thermocouples at different radial and/or axial positions to measure light-induced macroscopic temperature gradients (e.g., where the catalyst will generally have the highest temperature near the incident light).

In a refinement, the photoreactor comprises: a fluid (e.g., gas or liquid) inlet in fluid communication with the reaction volume; and a fluid (e.g., gas or liquid) outlet in fluid communication with the reaction volume; wherein the fluid inlet and the fluid outlet are at different positions relative to the reaction volume such that fluid entering the photoreactor via the fluid inlet passes through the reaction volume (e.g., and any particulate photocatalyst therein) before exiting the photoreactor via the fluid outlet. In some embodiments, the fluid inlet can be in fluid communication with a reservoir or other source of (gaseous or liquid) reactant(s) to the photoreactor. In some embodiments, the fluid inlet of a given photoreactor can be in fluid communication with the fluid outlet of another (different) photoreactor upstream, for example in a series arrangement of multiple photoreactors.

In another aspect, the disclosure relates to a method for performing a photocatalytic reaction, the method comprising: flowing a reactant (e.g., a gas- or liquid-phase reactant or reactant stream) through the reaction volume of the photoreactor according to any of the variously disclosed embodiments, refinements, etc., the photoreactor further comprising a particulate photocatalyst contained in the reaction volume; and irradiating the particulate photocatalyst with the external light transmission apparatus while flowing the reactant through the reaction volume, thereby activating the particulate photocatalyst and catalyzing conversion of the reactant to a reaction product. The photoreactor can be used to perform any of a variety of desired gas-phase or liquid-phase heterogeneous reactions with gas- or liquid-phase reactant(s) flowed over solid particular photocatalyst in the reaction volume during irradiation from the light transmission apparatus. Examples of suitable gas-phase reactions include (i) oxidation and partial oxidation (e.g., epoxidation) reactions (e.g., ethylene epoxidation, propylene epoxidation) for example using silver-based catalysts (e.g., Ag or AgCu nanostructures) or other catalysts (e.g., non-silver catalysts), (ii) carbon dioxide hydrogenation (e.g., methanation or reverse water gas shift) for converting carbon dioxide to sustainable fuels and chemicals, (iii) gas-phase ammonia synthesis, and (iv) hydrogenation or de-hydrogenation reactions on hybrid plasmonics (e.g., plasmonic metals coupled with non-plasmonic active sites to drive the chemistry). These are all industrially relevant reactions and carbon dioxide hydrogenation is particularly useful in the area of sustainable chemistry/catalysis. Examples of suitable liquid-phase reactions include (i) water-splitting of a (liquid) water reactant stream to form oxygen (O₂) and hydrogen (H₂) products, and (ii) liquid-phase carbon dioxide hydrogenation. More generally, the photocatalytic reaction can include both gas and liquid phases, for example including gas being bubbled through a liquid that carries it into the reactor.

Various refinements of the disclosed method are possible.

In a refinement, the reactant comprises a gas-phase reactant stream.

In a refinement, the reactant comprises a liquid-phase reactant stream.

In a refinement, conversion of the reactant to a reaction product comprises performing a reaction selected from the group consisting of oxidation, partial oxidation, carbon dioxide hydrogenation, ammonia synthesis, hydrogenation, de-hydrogenation, and water-splitting.

While the disclosed articles, apparatus, and methods are susceptible of embodiments in various forms, specific embodiments of the disclosure are illustrated (and will hereafter be described) with the understanding that the disclosure is intended to be illustrative, and is not intended to limit the claims to the specific embodiments described and illustrated herein.

### BRIEF DESCRIPTION OF THE DRAWINGS

For a more complete understanding of the disclosure, reference should be made to the following detailed description and accompanying drawings wherein:

FIG. 1 is a side view of a photoreactor according to the disclosure.

FIG. 2 is a cross-sectional axial view of a photoreactor according to the disclosure.

FIG. 3 includes graphs illustrating residence time distributions in an annular photoreactor according to the disclosure, a comparative conventional packed bed reactor (PBR), and a conventional Harrick reactor. Panel A) is a COMSOL-modeled residence time distribution of an inlet pulse (C(t) for both reactors) compared to the outlet pulse intensity for the photoreactor according to the disclosure compared to a conventional PBR of identical volume. Panel B) includes experimentally obtained data for a helium pulse obtained in the annular reactor compared to the commercial Harrick high temperature reactor chamber, suggesting that the Harrick reactor performs more similarly to the modeled conventional PBR.

FIG. 4 includes graphs illustrating measured rates of CO oxidation on α-Ag/Al₂O₃ catalysts. Panel A) includes thermal rate data for the CO oxidation reaction on 1.5 wt %, 3 wt %, 6 wt %, and 12 wt % Ag/α-Al₂O₃ catalysts, which show similar rates per gram of catalyst for each loading, consistent with operation in a kinetically limited regime. Panel B) illustrates that photo-rates for each catalyst loading between 1.5 wt % and 6 wt % remain similar, suggesting the absence of collective effects at these low to moderate loadings; for the 12 wt % catalyst, the photo-rates increase substantially, suggesting the emergence of collective effects. Panel C) illustrates enhancement factors calculated for each catalyst loading by dividing the photothermal rates by respective thermal rates measured under identical external heat supply.

FIG. 5 includes graphs illustrating spatial temperature and rate measurements in the annular photoreactor. Panel A) illustrates temperature increase measured under illumination for all four catalyst samples at the reactor interior (closest to the heater, black bars) and exterior (closest to the light source, white bars) under CO oxidation conditions. The inset figure shows a sketch of the relative thermocouple positions at the interior and exterior of the catalyst bed. Panel B) includes experimentally measured temperatures under thermal and photothermal conditions as a function of thermal setpoint for the 12 wt % catalyst. Panel C) includes thermal and photothermal temperature profiles in the annular reactor; the photothermal temperature profile suggests that most of the heating takes place closest to the light source. Panel C) includes experimentally measured thermal and photothermal reaction rates compared to thermal and photothermal Arrhenius rates, modeled in the reactor as a function of the distance, assuming that the reactants are at the measured equilibrium temperatures.

### DETAILED DESCRIPTION

The disclosure relates to a photoreactor for performing photocatalytic reactions with a particulate photocatalyst loaded in the reactor. The photoreactor includes an internal wall (e.g., duct or tube) having an outer surface and defining an interior volume; and a transparent external wall (e.g., duct or tube) having an outer surface and an opposing inner surface. The internal and external walls are spaced apart so that they together define a reaction volume between the walls (e.g., a circular annular reaction volume). The photoreactor further includes an external light transmission apparatus (e.g., a light source and/or a light guide) positioned around the external wall and being adapted to transmit light through the external and into the reaction volume. When a particulate photocatalyst loaded in the reaction volume is irradiated by external light transmission apparatus while a reactant is flowing through the reaction volume, a photocatalytic reaction can be performed to form a desired reaction product.

The photoreactor as more generally described herein can alleviate some of the prevailing issues associated with a commonly employed commercial stainless steel reaction chamber utilized in the field of plasmonic photocatalysis. The photoreactor promotes improved mass transfer, the ability to directly measure catalyst temperature and photothermal heating in-operando, superior resistance to contamination, easily serviceable parts, a scalable design, and potential integration with solar collection systems (e.g., could be implemented into parabolic trough collectors). The use of external rather than internal illumination opens up options for direct solar illumination, LED illumination, fiber optic illumination, and other customized bench-scaled or scaled-up designs. The internal portion of the reactor can be configured to employ a cartridge heater, coolant, or secondary illumination source depending on the desired application. Finite element modeling and experimental characterization of this annular design also suggests an improvement in residence time distribution, improved flow uniformity, and reduced channeling compared to conventional tubular reactors of identical active volume.

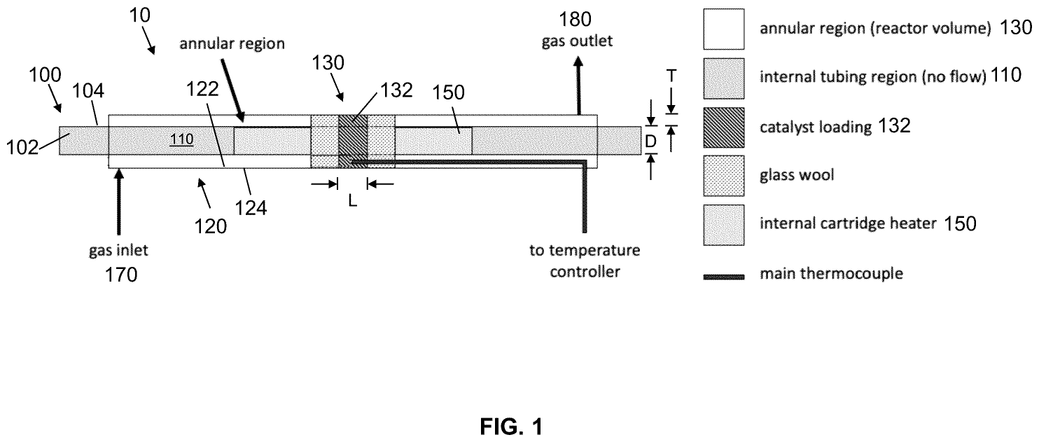

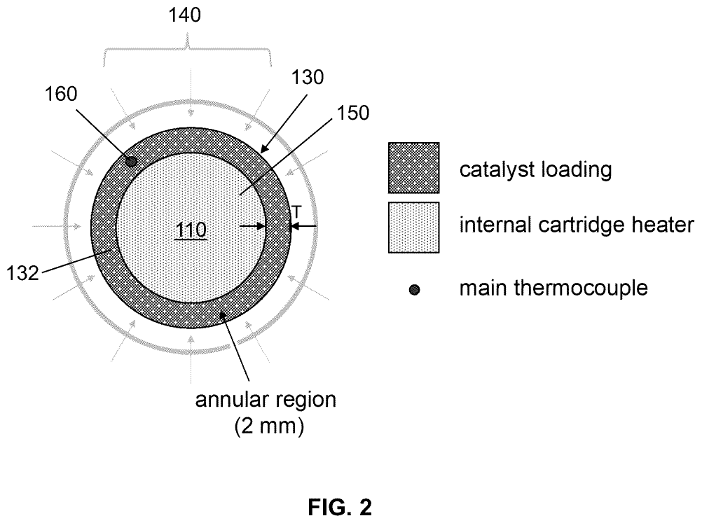

FIG. 1 and FIG. 2 illustrate a photocatalytic photoreactor 10 according to the disclosure. The photoreactor 10 includes a first (or internal) wall 100 having an outer surface 104 and an opposing inner surface 102. The first wall 100 can have any suitable structure such as an inner duct, tube, channel, or conduit. The inner surface 102 defines an interior volume 110, which can be an open interior space for a heater, second light source, heat transfer liquid flow, etc., for example having a diameter or other lateral dimension D. The photoreactor 10 further includes a second (or external) wall 120 having an outer surface 124 and an opposing inner surface 122. The second wall 120 can have any suitable structure such as an outer duct, tube, channel, or conduit. The second wall 120 is spaced apart from the first wall 100 such that the first wall 100 and the second wall 120 together define a reaction volume 130 between the first wall outer surface 104 and the second wall inner surface 122. As illustrated, reaction volume 130 can have a thickness T (e.g., annular gap width) and a length L. The photoreactor 10 further includes an external light transmission apparatus 140, such as a light source and/or a light guide. The second wall 120 is at least partially transparent, for example fully or partially transparent, such as being formed fully from a transparent material such as a glass, or being formed from a material having transparent sections where catalyst is to be loaded, etc. The reaction volume is sized and shaped to receive (e.g., and contain, retain, hold, etc.) a particulate photocatalyst 132 therein such that incident light passing (e.g., illustrated by the arrows in FIG. 2 emanating from the light source 140) through the second wall 120 from the second wall outer surface 124, to the second wall inner surface 122, and into the reaction volume 130 penetrates a substantial portion of the reaction volume 130 (e.g., thickness thereof) when a particulate photocatalyst 132 is contained therein. The light transmission apparatus 140 is positioned external to and at least partially around, such as fully or partially around the circumference of, the second wall outer surface 124 (e.g., external to the reaction volume 130). Further, the light transmission apparatus 140 is adapted to transmit light through the second wall 120 from the second wall outer surface 124, to the second wall inner surface 122, and into the reaction volume 130, such as fully or partially around the circumference thereof.

The thickness T of the reaction volume 130 can be expressed as the distance between the first wall outer surface 104 and the second wall inner surface 122, for example in a direction (locally) perpendicular to one or both of the wall surfaces. For example, in a cylindrical photoreactor with an annular reaction volume, the reaction volume thickness can be expressed as the annular difference in radii for two concentric tubes forming the first and second walls. Similarly, in a duct or channel photoreactor with a rectangular (e.g., square) cross section, the reaction volume thickness can be expressed as the difference in channel half-widths for two coaxial channels forming the first and second walls.

In embodiments, the reaction volume 130 can have thickness T in a range of 0.5 mm to 10 mm. More generally, the reaction volume thickness can be in a range of 0.5 mm to 10 mm or 1 mm to 3 mm, for example at least 0.1, 0.2, 0.3, 0.5, 0.7, 1, 1.2, 1.5, 2, or 2.5 mm and/or up to 1, 1.5, 2, 2.5, 3, 4, 5, 7, or 10 mm. The reaction volume thickness can be constant or variable along the length/axial direction (e.g., flow direction) of the photoreactor. The relatively small reaction volume thickness is selected such that incident light from the external light transmission apparatus is able to penetrate and illuminate a substantial portion of the reaction volume when it is filled with photocatalyst, thus providing the photocatalyst with the necessary light to induce its catalytic activity. As the reaction volume thickness increases, there is potentially a dead or inactive zone in the reaction volume (e.g., close to the first wall) where light does not penetrate and there is not substantial photocatalytic activity. In contrast to the photoreactor according to the disclosure, other annular photoreactors intended for homogeneous reactions have substantially larger reaction volume thicknesses, because incident light from the interior of such annular photoreactors can easily penetrate a larger/thicker (and typically clear) homogeneous reaction medium, which is in contrast to the heterogeneous reaction medium of the disclosed photoreactor.

In some embodiments, the reaction volume 130 has an elongate structure with a length (L)/thickness (T) ratio of at least 10. More generally, the photoreactor 10 and its corresponding reaction volume 130 can have any suitable length, where longer lengths (or higher aspect ratios UT) provide longer residence time for reaction within the reaction volume. For example, the photoreactor and/or its corresponding reaction volume can have an aspect ratio UT of at least 1, 2, 5, 10, 15, 20, or 30 and/or up to 10, 20, 30, 40, 50, 70, 100, 200, 300, 500, or 1000. In some embodiments, multiple photoreactors can be arranged in series to provide a desired total residence/reaction time. In some embodiments, multiple photoreactors can be arranged in parallel to provide a desired capacity or throughput for a given residence/reaction time.

In some embodiments, the interior volume 110 has a characteristic lateral dimension D in a range of 5 mm to 100 mm. The lateral dimension D of the interior volume 110 can be the (inner) diameter of a corresponding cylindrical tube for the first wall, the (inner) width of a corresponding rectangular duct or conduit for the first wall, etc., and the lateral dimension is generally perpendicular to a longitudinal or axial direction defined by the first wall. More generally, the lateral dimension of the interior volume can be in a range of 1 mm to 100 mm, 5 mm to 100 mm or 8 mm to 20 mm, for example at least 1, 2, 3, 4, 5, 6, 7, 8, 10, 15, 20, or 30 mm and/or up to 10, 15, 20, 30, 40, 50, 70, or 100 mm.

A variety of different geometries are possible for the photoreactor 10 and its corresponding walls 100, 120. For example and as generally illustrated in the figures, the first wall 100 can be a first cylindrical tube, the second wall 120 can be second cylindrical tube coaxially aligned with the first cylindrical tube, and the reaction volume can be a (circular) annular volume between the first cylindrical tube and the second cylindrical tube, such as where the reaction volume thickness is ΔR for the two cylindrical tube radii. Other geometries with non-circular cross sections are possible, such as rectangular or square, oval or elliptical, etc. Circular cross sections with the corresponding annular reaction volume are convenient from a construction standpoint due to the use of cylindrical tubes, but other geometries can provide the same benefits in terms of reactor performance as the annular design. For example, in another embodiment (not shown), the first wall 100 can be a first rectangular duct, the second wall 120 can be a second rectangular duct coaxially aligned with the first rectangular duct, and the reaction volume 130 can be a (rectangular or square) annular volume between the first rectangular duct and the second rectangular duct, such as where the reaction volume thickness is ΔW/2 for the two rectangular duct widths.

As described above, a typical problem associated with conventional photoreactors is that they are susceptible to contamination during normal use, but they are not easily cleaned for continued use for the same and/or a different reaction. The disclosed photoreactor 10 is designed to be resistant to contamination and can be more easily cleaned. For example, the reactor body can be constructed of quartz tubing, with stainless-steel fittings located only at either end of the tubular reactor body (i.e., making the steel components less susceptible to contamination and/or easily replaceable as a small component). Quartz tubing is an easy to clean and affordable component, which easily tolerates exposure to both aqua regia and Piranha solutions, and is replaceable upon breakage or any irreversible contamination.

In some embodiments, the first wall 100 can be at least partially transparent, for example fully or partially transparent, such as being formed fully from a transparent material such as a glass, or being formed from a material having transparent sections where catalyst is to be loaded, etc. In such case, the photoreactor 10 can further include a second light source (not shown) in the interior volume 110, where the second light source is adapted to deliver light into the reaction volume 130 through the first wall 100.

In some embodiments, the second wall 120 can be formed from or otherwise include quartz glass. More generally, the second (or external/outer) wall 120 of the photoreactor 10 can be formed from or otherwise include any suitable transparent material that permits transmission of light from the external light transmission apparatus into the reaction volume, and that has sufficient mechanical, physical, and chemical properties to withstand the reaction conditions within the photoreactor. Quartz glass is particularly useful because it has high transparency/transmittance across a wide range of light wavelengths, and it has high thermal resistance, making it suitable for high-temperature reaction conditions. Other suitable materials can include other glasses (e.g., borosilicate glasses), transparent plastic materials (e.g., acrylic glass), etc., for example when the photoreactor is intended for reactions under relatively mild conditions (e.g., low-P, low-T reaction conditions).

In some embodiments, the first wall 100 can be formed from or otherwise include quartz glass. More generally, the first (or internal/inner) wall of the photoreactor 10 can be formed from or otherwise include the materials as described above for the second wall 120. For example, the first wall 100 can include a transparent material when the interior volume 100 is intended to include a second light source providing illumination to complement that of the external light source 140. In other embodiments, the first wall 100 can be formed from or otherwise include a non-transparent material, for example a ceramic material such as alumina. Non-transparent materials are suitable when there is no intention to include a second light source in the interior volume 110. Non-transparent materials also can be selected based on their thermal conductivity to promote more efficient heat transfer, for example when the interior volume 110 contains a heating element, a heat transfer fluid (e.g., gas or liquid), etc. While metal materials such as stainless steel can be used as the material for the first wall 100, metals are often preferably avoided because various photocatalytic reactions can easily contaminate metal surfaces with deposits. In contrast, such contamination is often avoided, limited, or otherwise reduced with quartz glass or ceramic surfaces, which are also relatively easier to clean or decontaminate as compared metals and other materials.

In some embodiments, first wall 100 includes an at least partially porous support (e.g., at the first wall inner surface 102) and a selectively permeable membrane adjacent (e.g., adhered or bound) to the porous support (e.g., at the first wall outer surface 104). Alternatively or additionally, the second wall 120 can include an at least partially porous support (e.g., at the second wall outer surface 124) and a selectively permeable membrane adjacent (e.g., adhered or bound) to the porous support (e.g., at the second wall inner surface 122). In embodiments, one or both of the inner and outer walls 100, 120 can incorporate a selectively permeable membrane, for example being selectively permeable to one or more reaction products, but impermeable to other reaction products, reactants, reaction medium components, etc. The inclusion of a membrane can facilitate separation and removal of a particular product as it is formed in the reaction volume during reaction, for example to provide a purified product stream, prevent reverse reactions from occurring, etc. For example, hydrogen (H₂)-permeable membranes are generally known in the art and can be used when the photoreactor is used to perform a photocatalytic water-splitting reaction. A water-splitting reaction can be performed to product both oxygen (O₂) and hydrogen (H₂) as desired products, but the reversible nature of the water-splitting reaction can lead to re-formation of water in the reaction volume, thus reducing overall conversion. Examples of suitable catalysts for water-splitting include Pt, NiMo, and/or Ru for hydrogen evolution, and Ir, Ni, and/or Co for oxygen evolution. The catalyst materials (e.g., a pair catalyst materials including one for hydrogen evolution and one for oxygen evolution) can be immobilized on or otherwise coupled to a light-absorbing semiconductor support (e.g., TiO₂) and/or a plasmonic component (e.g., Ag, Au, Cu, Al as described below) to absorb light and provide the photocatalyst. Accordingly, inclusion of a hydrogen-permeable membrane (i.e., which also is water- and oxygen-impermeable) allows hydrogen to be removed and recovered from the reaction volume as it is formed, thus preventing the reverse water-formation reaction and increasing the overall production of both oxygen and hydrogen products. Suitable hydrogen-permeable membranes include those based on silica, and these are relatively thin (e.g., on the order of hundreds of nanometers, such as at least 100, 200, or 300 nm and/or up to 500, 700, or 1000 nm) as well as transparent (i.e., making them suitable for use at inner or outer wall where light transmission is desired). Examples of suitable hydrogen-permeable membranes include commercially available sulfonated polytetrafluoroethylene membranes (e.g., NAFION-based proton-permeable membranes), perovskite- or other ceramic-based membranes that permeate molecular hydrogen or protons, etc.

Given the typically thin nature of selectively permeable membranes, they are generally used in combination with an at least partially porous support to provide structural integrity to the wall and membrane, but including sufficient open areas to allow fluid flow therethrough (e.g., species passing through the membrane can also pass through the porous support), and optionally to allow light transmission therethrough (e.g., when used for a transparent wall). The porous support can be fully or partially porous in the sense that the first or second wall can be fully formed from a porous support/membrane combination, or the first or second wall can include sections of the porous support/membrane combination where catalyst is to be loaded for the reaction volume. A suitable porous support can include a porous tube or duct, a mesh (e.g., stainless steel), etc. upon which the membrane is adhered or mounted, or two porous or mesh structures between which the membrane is sandwiched. Examples of suitable porous materials include porous alumina, porous quartz or glass, porous plastics (e.g., high-density polyethylene (HDPE)), for example in tube or duct form. Different porous materials can be selected based on their ability to withstand high-temperature conditions in view of a particular reaction to be performed in the photoreactor. The open areas of the of the porous support allow flow of the species transported across the membrane, and in some cases the porous support also allows for light transmission (e.g., a transparent support material, open areas in a mesh, etc.).

As illustrated, the photoreactor 10 can include a fluid (e.g., gas or liquid) inlet 170 in fluid communication with the reaction volume 130m and a fluid (e.g., gas or liquid) outlet 180 in fluid communication with the reaction volume 130. The fluid inlet 170 and the fluid outlet 180 are at different positions relative to the reaction volume 130 such that fluid entering the photoreactor 130 via the fluid inlet 170 passes through the reaction volume 130 (e.g., and any particulate photocatalyst 132 therein) before exiting the photoreactor 10 via the fluid outlet 180. In some embodiments, the fluid inlet 170 can be in fluid communication with a reservoir (not shown) or other source of (gaseous or liquid) reactant(s) to the photoreactor 10. In some embodiments, the fluid inlet 170 of a given photoreactor 10 can be in fluid communication with the fluid outlet 180 of another (different) photoreactor 10 upstream, for example in a series arrangement of multiple photoreactors 10.

In slurry-type photoreactors often used for liquid-phase photo-catalysis applications, several reactor and illumination conditions are employed. External illumination is sometimes performed from the sides of the reactor. In this setup, illumination efficiency (or light utilization) can be lower than in other designs since light is more easily reflected from the curved face of the cylindrical reactor tubing. Furthermore, illumination is often only conducted from one side of the reactor, severely reducing illumination effectiveness at the dark side of the reactor. This is especially problematic if the slurry material is dark and prevents light from penetrating the full diameter of the reactor. In the disclosed gas phase photoreactor, the surface area of catalyst that is in direct contact with light is maximized minimizing the thickness of the annular region of the reactor through which light is required to pass. The photoreactor in examples below features an annular region that is 2 mm thick. The use of smaller photocatalyst particles can also support deeper penetration into the catalyst bed upon illumination.

The light transmission apparatus 140 is not particularly limited and can include one or both of a light source to generate and emit light and a light guide to receive and transmit light from a different light source. In an embodiment, the light transmission apparatus 100 can include at least one light source and at least one light guide, for example a light source mounted to a light guide, which is mounted to the second wall 120, such that the light guide distributes light from the light source into and around the reaction volume 130.

In some embodiments, the light transmission apparatus 140 includes a light source, which is configured (e.g., positioned, adapted) to transmit light around the (entire) circumference of the second wall 120 and into the reaction volume 130. The light source in general can be any known device or apparatus capable of generating and emitting light (or electromagnetic radiation) in or across one or more wavelengths. The light source can be any suitable lamp or light, for example an LED lamp. The light source can be selected so that it can emit light in one of more of the UV (e.g., 10-400 nm or 200-400 nm), visible (e.g., 380-750 nm, 380-800 nm, or 420-680 nm), and IR (e.g., 700 nm-1 mm) spectra, or at a wavelength or subset of wavelengths therein, depending the excitation wavelength(s) of the intended photocatalyst. The light source can be mounted on or adjacent to the second wall 120. The light source can include multiple light sources, for example including an array of a plurality of lights distributed around the second wall 120, a sleeve or jacket containing light(s) therein to be mounted around the second wall 120, etc.

In some embodiments, the light transmission apparatus 140 includes a light guide, which is configured (e.g., positioned, adapted) to transmit received light around the (entire) circumference of the second wall 120 and into the reaction volume 130. The light guide can be any suitable optical device that receives light from an external source, for example a lamp or ambient sunlight, and then redirects the received light to a plurality positions around the photoreactor 10 and into the reaction volume 130. Examples include optical fibers, a fiber optic light guide, an annular light guide, a solar collector, etc. The light guide can be mounted on or adjacent to the second wall 120.

The photoreactor 10 can include particulate photocatalyst 132 contained in the reaction volume 130. The particulate photocatalyst 132 can include a plurality of photocatalyst particles as a packing or filling in the reaction volume 130 with sufficient void volume for fluid flow through the reaction volume and around/over the photocatalyst particles 132. The photoreactor can further include a means for retaining the photocatalyst within the reaction volume, which means can also be positioned within or adjacent to the reaction volume. For example, glass or quartz wool inserted into the gap between the inner and outer walls can be used to hold or secure the photocatalyst in the reaction volume. Such glass or quartz wool retaining means can be suitable for gas-phase reactions (e.g., a gaseous reaction medium fed to the reaction volume, where it passes over and through the wool and particulate photocatalyst therein). Alternatively, a mesh or porous support having higher structural integrity than glass wool, but with sufficient open areas to retain the photocatalyst while allowing fluid flow therethrough, can be used as a retaining means. Such mesh or porous retaining means can be suitable for gas-phase reactions or for liquid-phase reactions (e.g., a liquid reaction medium fed to the reaction volume, where it passes over and through the mesh/porous support and particulate photocatalyst therein).

Photocatalysts are generally known in the art and generally include materials capable of exhibiting catalytic activity upon the absorption of light (e.g., in general or of specific wavelength(s)), such as resulting from the formation of excited charge carriers, free radicals, etc. Plasmonic and hybrid plasmonic photocatalysts can include plasmonic metal nanoparticles, for example Ag, Au, Cu, Al, and combinations thereof, such as with other plasmonic metals or with other (catalytic) metals such as Pt, Pd, Ru, Rh, etc. Combinations of such metals can include alloys, core-shell structures (e.g., plasmonic metal core, other metal coating/shell), and decorated particulate structures (e.g., plasmonic metal larger particles with other smaller metal particles decorated on the surfaces thereof). Plasmonic metals interact with incident light via localized surface plasmon resonance (LSPR) to generate their catalytic activity. The light-induced catalytic activity can be mediated by excited charge carriers (charge transfer mechanism), elevated fields at the surfaces of the particles, or photothermal heating effects which can activate adsorbates (reactants) attached to the surfaces of the particles. These processes may work synergistically in plasmonic catalysts. Other photocatalyst materials can include semiconductor materials such as transition metal oxides and semiconductors, for example CeO₂, TiO₂, etc. The photocatalysts can further include a (catalytic or non-catalytic) support, for example alumina (Al₂O₃), silica (SiO₂), etc.

In some embodiments, the particulate photocatalyst 132 has a particle size in a range of 100 μm to 500 μm or 0.005 μm to 500 μm. More generally, the particulate photocatalyst can have a particle size of at least 0.005, 0.01, 0.02, 0.05, 0.1, 0.2, 0.5, 1, 2, 5, 10, 20, 50, 100, or 200 μm and/or up to 0.05, 0.1, 0.2, 0.5, 1, 2, 5, 10, 20, 50, 100, 200, 300, 400, or 500 μm. The foregoing sizes and size ranges can represent average sizes (e.g., weight-, volume-, or number-averages) or size distributions (e.g., 1/99%, 5/95%, or 10/90% cut points of a cumulative size distribution based on weight, number, or volume) for the particles, for example where the size can represent an approximate or spherical-equivalent diameter of the particles. Additionally, the foregoing sizes can represent the size of the photocatalyst particle as a whole (e.g., including a support with smaller photocatalytic particles thereon).

In some embodiments, the particulate photocatalyst 132 can be adhered to at least one of the first wall outer surface 104 and the second wall inner surface 122. More generally, the particulate photocatalyst 132 can be coated (e.g., as a discontinuous layer or discrete particles), bound, or otherwise immobilized on one or both of the interior photoreactor walls 100, 122 facing the reaction volume 130. Such adhered particulate photocatalyst 132 can be in addition to or instead of the free particulate photocatalyst 132 described above as generally loose packing or fill in the reaction volume 130. The adhered particulate photocatalyst 132 can be the same as or different from the free particulate photocatalyst 32, and it generally can be selected from the same materials, sizes, etc. Common photocatalyst 132 materials are relatively easy to deposit as particulates on such as quartz (e.g., roughened quartz, such as for the first and/or second wall), alumina (e.g., such as for the first wall), etc., making them easily adaptable for use with common materials used for the photoreactor walls 100, 120.

The interior volume 110 of the photoreactor 10 can contain or be adapted to contain one or more structures, apparatus, or compositions for use during operation of the photoreactor 10. In some embodiments, the interior volume 110 defined by the first wall 100 is an open interior volume adapted to receive one or more of (i) a heating apparatus 150 adapted (or configured, positioned) to deliver thermal energy into the reaction volume 130 through the first wall 100, (ii) a second light source (not shown) adapted (or configured, positioned) to deliver light into the reaction volume 130 through the first wall 100 (e.g., when formed from a transparent material), and (iii) a heat transfer liquid (not shown) flowing through the open interior volume 100 to heat or cool the reaction volume 130 via heat transfer through the first wall 100. In some embodiments, the photoreactor 10 further includes the heating apparatus 150 in the interior volume 110, where the heating apparatus 150 is adapted to deliver thermal energy into the reaction volume 130 through the first wall 100.

In some embodiments, the photoreactor 10 can include a thermocouple 160 or other temperature sensor positioned within the reaction volume 130. The thermocouple 160 can be positioned so that it is in contact with the particulate photocatalyst 132 (when present). In some embodiments, the photoreactor 132 can include multiple embedded or otherwise positioned thermocouples 160 at different radial and/or axial positions to measure light-induced macroscopic temperature gradients (e.g., where the catalyst 132 will generally have the highest temperature near the incident light).

### Examples

The following examples illustrate the disclosed apparatus and methods, but are not intended to limit the scope of any claims thereto. In the following examples, a photoreactor generally according to the disclosure is described and used to perform an illustrative photocatalytic reaction.

The annular photoreactor used in the examples consists of two concentric quartz tubes of 8 mm (10 mm) and 16 mm (14 mm) outer (inner) diameters. The annular region is 2 mm thick. A cartridge heater is located at the interior of the internal tubing, the catalyst is loaded into the annular region, and the system is illuminated externally. A thermocouple is embedded into the catalyst layer to directly observe the catalyst temperature and any photothermal gradients induced upon illumination.

The annular quartz tube photoreactor used in the examples addresses issues and deficiencies that have hampered previously employed commercial reactors. The photoreactor was used in an illustrative photocatalytic reaction to study the rate enhancement for the CO oxidation reaction over plasmonic, monometallic Ag nanoparticle catalysts supported on α-Al₂O₃. The effect of the Ag nanoparticle density and clustering on equilibrium photothermal heating was evaluated by comparing plasmonic rate enhancements across a range of catalyst loadings of 1.5, 3, 6, and 12 wt % Ag on α-Al₂O₃ (the percentage loading of Ag nanoparticles in the catalyst bed by weight). The results suggest that steady state heating of the catalyst bed cannot account for the magnitude of the reaction rates observed for the illuminated catalyst bed. This is the case even for high loadings and clustering of Ag nanoparticles, where collective heating becomes significant. This suggests that local effects—including plasmon-induced activation of adsorbates (reactants) via their electronic excitation, or photothermal heating of the nanoparticles that remains highly localized to the individual nanoparticles—are the drivers of the measured LSPR-induced chemical reactivity.

### Reactor Simulation

The annular quartz photoreactor consisted of two tubes of different radii oriented coaxially. The design of the reactor as illustrated in FIG. 1 and FIG. 2 above was aided by fluid flow simulations performed with COMSOL Multiphysics software, which was employed to solve the governing fluid flow equations. This permitted evaluation of reaction rates. In short, the simulations were used to characterize the residence time distribution and flow patterns in an annular reactor, to ensure that under operating conditions the reactor geometry allowed for the plug flow conditions required to accurately measure kinetic rates.

Two coupled two COMSOL modules—Laminar Flow and Transport of Diluted Species—were used to model the behavior of a tracer sample throughout the annular photoreactor geometry. The tracer sample was defined as a smoothed rectangular pulse (to emulate an experimental pulse), entering at the reactor inlet arm. The velocity profile of fluid in the reactor was calculated at the center of the reactor at the position in which the catalyst would be loaded. The velocity profiles for the annular reactor design were compared to a conventional PBR, for which analogous fluid flow simulations were performed. As illustrated by the resulting velocity profiles (not shown), the annular photoreactor design maintains a similar velocity magnitude as the PBR at the center portion of the reactor, where the catalyst would be loaded.

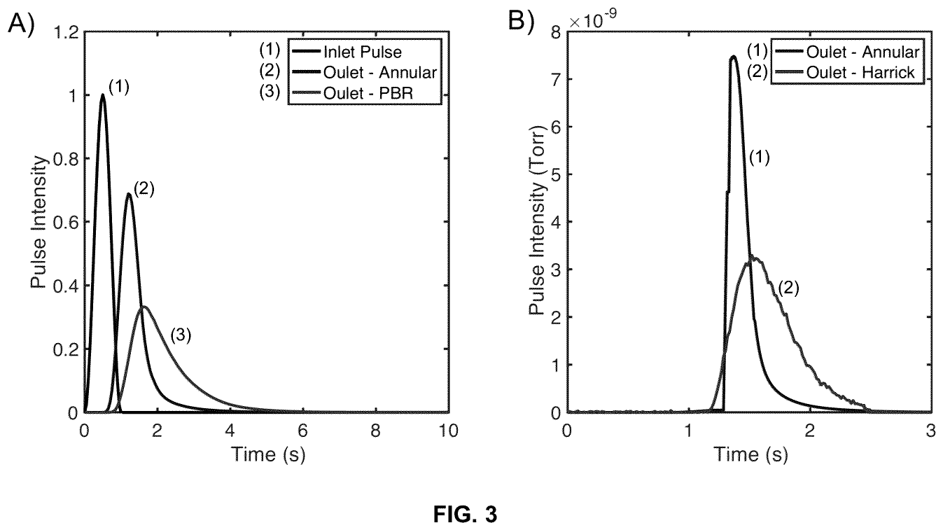

FIG. 3 includes graphs showing the modeled residence time distributions from the COMSOL simulations. Panel A) in FIG. 3 shows the modeled residence time distributions from the COMSOL simulations of the annular reactor and packed bed reactor (PBR) of equivalent volume. The residence time distribution conveys information about how long the material—in this case the gaseous reactant mixture—entering the reactor takes to pass through the total volume. In an ideal plug flow reactor, all the gas molecules should take the same amount of time between entering and exiting a reactor, leading to a narrow and symmetric residence time distribution. Deviations from an ideal residence time distribution (e.g., broadening, skewedness) can indicate channeling or other flow irregularities. If the reactor is prone to channeling, where some of the gas molecules pass through regions of low resistance, these molecules may not have sufficient time to interact with the catalyst. If there is internal circulation, other gas molecules may reside a longer time in the reactor. The amount of time that a reactant spends in a reactor and in contact with the catalyst can affect the measured reaction rate, which is why it is preferable to have each molecule spending a similar amount of time passing through the photoreactor. The simulations indicate that the annular reactor yields a narrower residence time distribution than the packed bed reactor. This trend is similar to what was experimentally observed in comparing the annular photoreactor to the Harrick high temperature reaction cell, a commercial reactor setup. Panel B) in FIG. 3 includes experimentally obtained data for a helium pulse obtained in the annular reactor compared to the commercial Harrick high temperature reactor chamber. As illustrated in panel B), the Harrick cell yields a residence time distribution more like that of a conventional PBR.

### Photocatalyst

Silver (Ag) nanoparticles of spherical shape approximately 60 nm in diameter were synthesized using a polyol method. Briefly, 8 mL of ethylene glycol (EG, JT Baker) was heated in a glass scintillation vial to 160° C. for one hour to remove residual water. Subsequently, 8 mL of ethylene glycol containing 500 mg of polyvinylpyrrolidone (PVP, Aldrich MW: ˜55,000) was added to the heated ethylene glycol, and the final solution was briefly mixed by hand. PVP acts as a polymeric stabilizer for the spheres. After 10 minutes, 50 mg of silver nitrate (Aldrich, 99.5%) dissolved in 2 mL of EG was quickly burst into the solution to facilitate the reduction of silver salt into metal nanoparticles. Over the course of a ˜30-minute period, the silver forms a colloidal solution which changes in appearance from a brown, to yellow, and finally an opaque yellow-green color. After 30 minutes, the reaction solution was removed from heat and quenched in an ice bath. The as-synthesized particles were washed once with acetone (Fisher, 99.6%) and once with water (18.2 MΩ cm, Millipore) to remove residual reagents from the solution and excess PVP from the nanoparticle surface. The washed particles were stored in water for no longer than one week before use in catalyst preparation.

The Ag nanoparticles were imaged using bright field scanning transmission electron microscopy (STEM), which showed that Ag nanoparticles were spherical with an average diameter of 64±9.5 nm. The optical properties of the nanoparticles were characterized using UV-vis spectroscopy, collected with a Thermo Scientific Evolution 300 spectrophotometer. 100 μL of the washed nanoparticle solution was diluted with water prior to measurement. The UV-vis extinction spectrum of the nanoparticles suspended in water was evaluated, demonstrating a plasmon resonance near 420 nm.

The Ag nanoparticle catalysts were supported on a mechanically stable, optically and chemically inert, low surface area α-Al₂O₃ support at different Ag weight loadings. Specifically, after nanoparticle synthesis, Ag nanoparticle catalysts were prepared by incorporating the entire solution of particles with an aqueous mixture containing α-Al₂O₃ (Alfa Aesar, 99.95%) under magnetic stirring. Varying the total amount of support material allowed for tuning of the final weight loading of the metal between ˜1.5-12 wt %. After 3 hours of stirring, 1 mL of 1M NaNO₃ (Acros Organics, >99%) was added to destabilize and facilitate deposition of the nanoparticles onto the support. The approximate catalyst loading was confirmed by weighing the mass of the catalyst support prior to and after the addition of the nanoparticles. The catalyst slurry was washed in water and dried overnight in a vacuum oven at 40° C. All catalyst samples were ground, mechanically pressed into pellets, and subsequently sieved using a mesh to obtain a final fraction with nanoparticle size/diameter (dₚ) ranging from 255 μm<dₚ<350 μm. The particle size was chosen to promote a reasonable pressure drop over the catalyst bed while suppressing channeling and mass transport limitations in the reactor.

STEM imaging of the Ag nanoparticle catalysts was also performed. The STEM images revealed that higher loaded catalysts exhibited not only a higher average particle density but also a higher propensity for particles to aggregate and cluster. It was found that while nearly all nanoparticles in the 1.5 wt % and 3 wt % catalysts were isolated or in very small clusters of 2-5 nanoparticles, clustering was very prominent in 12 wt % catalysts. Using the same spectrophotometer as above, the final as-prepared and treated catalysts were characterized using diffuse reflectance UV-vis spectroscopy by employing a Harrick Praying Mantis chamber equipped with UV-vis transparent SiO₂ windows. Diffuse reflectance UV-vis characterization of the catalyst suggested that the plasmon peak of the Ag particles was present and did not deteriorate after about 10 hours on-stream of reactor operation.

### Reactor Assembly

The photoreactor design, shown in FIG. 1 and FIG. 2, provided an annular region of 2 mm thickness. The catalyst was loaded into the reactor, which was operated in a vertical configuration. The reactor was heated from the interior of the reactor, using a cartridge heater positioned in direct contact with the internal quartz tube. The temperature of the catalyst bed within the reactor was monitored using a thin stainless steel sheathed thermocouple embedded directly within the catalyst. Half of the annular region in the azimuthal direction was loaded with the catalyst, and the other half was loaded with inert α-Al₂O₃ of equivalent particle diameter. For photothermal operation, the catalyst-loaded portion of the annular photoreactor was illuminated externally using two adjacent Dolan-Jenner FIBERLITE 180 light sources, both equipped with IR cutoff filters. The peak intensity of the light was measured to be approximately 400 mW/cm² at the inside surface of the exterior tube (i.e., where the catalyst sits), and the wavelength profile of the light source spanned from about 200-800 nm, with the majority of the light intensity being within about 400-600 nm. When obtaining photothermal rate data, the temperature control system was maintained at a constant heater power (i.e., the power supplied to the cartage was constant in each given set of thermal and photothermal measurements), which permitted comparison of thermal and photothermal rates at a constant external heater temperature. Chemically and optically inert quartz wool was used to keep the catalyst bed in place, ensure a uniform bed thickness, and prevent channeling or other flow irregularities. The catalyst layer was typically measured to be between 4-5 mm in length.

To measure the temperature within the catalyst bed at different positions, thermocouples were embedded in the catalyst bed. The thermocouples were wrapped in several layers of polyfluorotetraethylene (PTFE) sealant tape to minimize artificial temperature increases measured when light impinges directly on the thermocouple. It was found that wrapping the thermocouple with PTFE tape reduced the measured temperature increase under illumination, which was attributed to the direct light-induced heating (or even electronic excitations) of the stainless steel thermocouple sheath.

### Reactor Operation

The photoreactor was used to study CO oxidation as a probe reaction. The experiments were conducted at 100 sccm and 5% CO and 5% O₂, with a balance of nitrogen. All reactions were operated under a kinetically limited regime at conversions below 5%, excluding two data points where the plasmonic enhancements pushed the reaction conversion to values higher than 5%. Reaction products were examined using gas chromatography (Agilent 7890B).

All catalysts were pretreated by calcination at 200° C. in 20% O₂, balance N₂ for 3 hours to burn off residual organic stabilizer and were subsequently reduced at 200° C. in 20% H₂, balance N₂ to reverse any surface oxidation imposed during the calcination step. Afterward, the catalyst was subjected to the initial reaction conditions and allowed to reach steady state overnight (typically 12 hours) before collecting reaction rate data. The reactor was operated at atmospheric pressure.

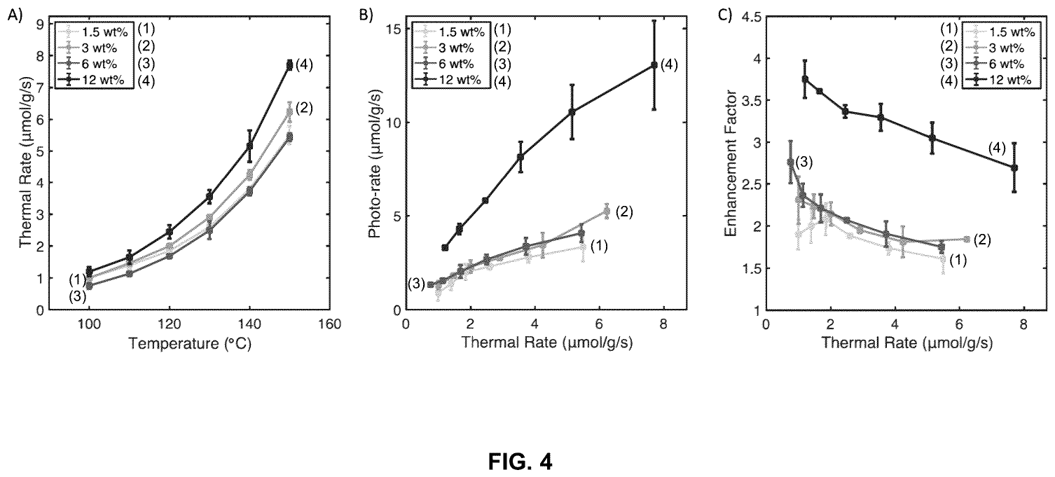

The data in panel A) of FIG. 4 show that the CO oxidation rates, measured at temperatures between 100-150° C. (no light illumination), were similar for the four catalysts with different Ag loadings. This consistency in the measured rates indicates that the reactor is operating in a kinetic regime, wherein the observed rate is not influenced by mass transfer limitations, even at higher weight loadings. The data in panel B) of FIG. 4 show the photo-rates on different catalysts plotted as a function of thermal rates. The photo-rate was calculated by subtracting the reaction rate measured under thermal conditions from the respective rates measured under photothermal conditions at the same power supply to the external heater. The data show that the photo-rates normalized per gram of Ag are very similar for catalyst loadings of 1.5, 3, and 6 wt %, suggesting that any collective nanoparticle interactions (such as collective heating), do not appear to emerge for these low loading samples. In other words, the data suggest that each nanoparticle operates independently under illumination. On the other hand, for the 12 wt % catalyst, it was found that the photo-rates normalized per gram of Ag exceed those of the lower loaded catalysts. The data show that at this higher loading collective effects arise, giving an additional boost to the reaction rates. It was hypothesized that at these higher loadings, the Ag clustering could lead to collective heating effects, which can drive up the reaction rate under illumination. This hypothesis is consistent with previous findings that showed collective heating effects only emerge at high nanoparticle densities, and that at low intensities the effect of photothermal heating is negligible, and that the plasmonic rate enhancement observed in these systems must be attributed to non-thermal processes (charge carrier driven chemistry). A similar trend in the enhancement factor (i.e., ratio of photothermal rate relative to thermal rate) as a function of thermal rate is shown panel C) of FIG. 4.

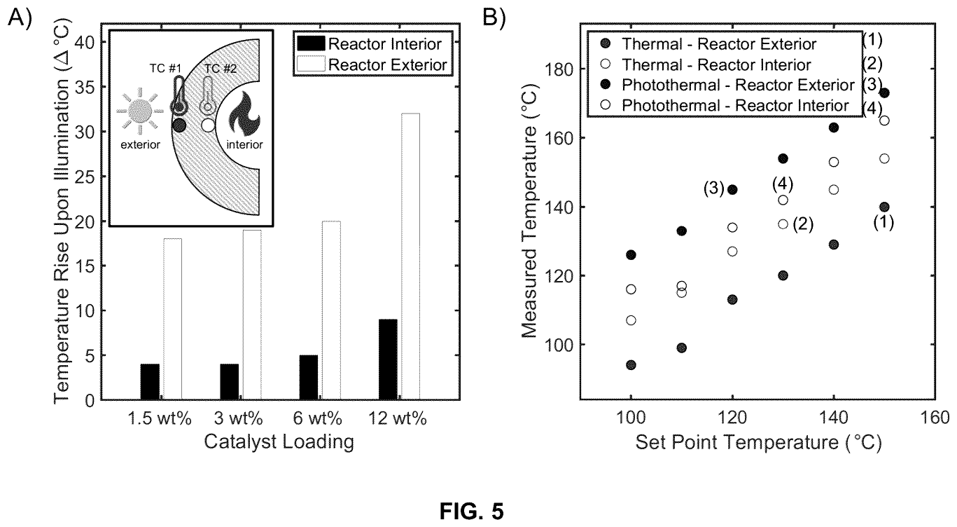

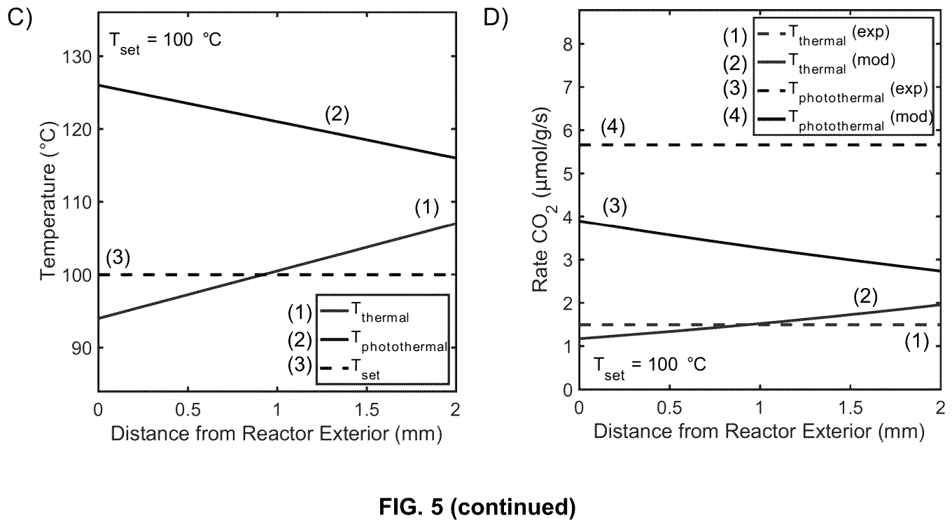

To further explore the relationship between nanoparticle clustering, equilibrium heating, and the observed photo-rates, thermocouples were embedded in the catalyst bed to measure the temperature increase for the four catalysts under specific reaction conditions. Before illuminating the catalysts, an external thermal setpoint of 100° C. was selected (i.e., the setpoint at which the corresponding thermal measurements were performed). The same heater power was applied when performing corresponding photocatalytic measurements. Thin PTFE-wrapped thermocouples placed as close to the light source as possible (at the exterior wall of the annular region) and as close to the heater as possible (at the interior wall of the annular region) were used to measure the thermal and photothermal temperature gradients for each case. An illustration of this setup is provided in the inset of panel A) of FIG. 5. It was found that the PTFE-wrapped thermocouple tends to overestimate the temperature reading of the catalyst under illumination, by approximately ˜5° C., when positioned near the light source.

The data in panel A) of FIG. 5 show measured temperature increases for each catalyst under illumination for the two different regions of the reactor with the heater kept at the power setpoint identical to that required for the thermal measurements at 100° C. As illustrated, the extent of measured heating under illumination is more significant directly under the light source (reactor exterior) compared to far from the light source (reactor interior). The data show that there were relatively similar temperature increases for the 1.5 wt %, 3 wt %, and 6 wt % cases, with only small changes in temperature observed with increasing loading. On the other hand, the measurements also indicate that the 12 wt % loading case exhibits a significantly larger increase in temperature under light. This is consistent with a regime in which highly clustered, high density nanoparticle catalysts yield collective heating that can be observed at the macroscopic level.

Identical measurements to those in panel A) of FIG. 5 were performed, measuring the thermal and photothermal temperature profiles in the annular reactor for thermal setpoint temperatures ranging between 100 and 150° C. (i.e., the catalyst temperature controlled by the external heater under thermal conditions in the absence of illumination). In these measurements, the two catalysts loadings were the 6 and 12 wt % Ag loadings. The data in panel B) of FIG. 5 show the measured temperatures recorded at the interior and exterior annular reactor positions under thermal conditions and photothermal conditions for the example of the 12 wt % catalyst. The corresponding data for the 6 wt % (not shown) follows a similar trend. Assuming a linear temperature gradient between the two positions in the reactor—this assumption is reasonable since the reactor has a very short radial length of ˜2 mm24—temperature profiles across the reactor were estimated. One of these temperature profiles is shown in panel C) of FIG. 5 for the 12 wt % catalyst at a thermal setpoint of 100° C. Corresponding temperature profiles at different thermal setpoints for the 6 wt % catalyst and the 12 wt % catalyst were also determined (not shown).

It was next evaluated whether the extent of the measured illumination-induced equilibrium heating could describe the plasmonic rate enhancements that were experimentally measured under illumination for the CO oxidation reaction. Using the Arrhenius rate constant measured in the temperature-dependent thermal studies (panel A) of FIG. 4) and the estimated temperature profiles, the anticipated photothermal rate was calculated as a function of the position in the reactor for the 6 wt % and 12 wt % catalysts assuming that the photothermal reaction is driven solely by the illumination-induced equilibrium temperature enhancement. Panel D) of FIG. 5 shows the calculated Arrhenius reaction rates under thermal and photothermal operation for the 12 wt % catalyst at a thermal setpoint of 100° C. Corresponding data for the 6 wt % catalyst and the 12 wt % catalyst at other thermal setpoint temperatures were also determined (not shown).

The data in panel D) of FIG. 5 show that the predicted Arrhenius photothermal rate is well below the photothermal rate experimentally measured when the catalysts are evaluated under illumination. This is very different compared to the thermal measurements (no illumination), for which the measured local temperatures accurately predict the magnitude of the reaction rates. The data panel D) of FIG. 5 show that steady state catalyst heating cannot completely capture the behavior of the systems and that non-thermal effects are involved. Identical observations were made for the case of the 6 wt % catalyst (not shown).

The results indicate that as the catalyst loading changes from 6 wt % to 12 wt %, the total photo-rate per gram of Ag attributed to these non-Arrhenius effects also increases. This could be attributed to a few potential factors. Ultimately, the data show that while photothermal equilibrium heating may play some role in observed plasmonic rate enhancements under conditions of broadband continuous illumination, there are significant additional contributions that cannot be described by the equilibrium heating of the catalyst bed.

Because other modifications and changes varied to fit particular operating requirements and environments will be apparent to those skilled in the art, the disclosure is not considered limited to the example chosen for purposes of illustration, and covers all changes and modifications which do not constitute departures from the true spirit and scope of this disclosure.

Accordingly, the foregoing description is given for clearness of understanding only, and no unnecessary limitations should be understood therefrom, as modifications within the scope of the disclosure may be apparent to those having ordinary skill in the art.

All patents, patent applications, government publications, government regulations, and literature references cited in this specification are hereby incorporated herein by reference in their entirety. In case of conflict, the present description, including definitions, will control.

Throughout the specification, where the compositions, processes, kits, or apparatus are described as including components, steps, or materials, it is contemplated that the compositions, processes, or apparatus can also comprise, consist essentially of, or consist of, any combination of the recited components or materials, unless described otherwise. Component concentrations can be expressed in terms of weight concentrations, unless specifically indicated otherwise. Combinations of components are contemplated to include homogeneous and/or heterogeneous mixtures, as would be understood by a person of ordinary skill in the art in view of the foregoing disclosure.

### LIST OF DRAWING ELEMENTS

10 photocatalytic photoreactor
100 first wall (102 inner surface, 104 outer surface)
110 interior volume (lateral dimension D)
120 second wall (122 inner surface, 124 outer surface)
130 reaction volume (thickness T, length L)
132 particulate photocatalyst
140 external light transmission apparatus
150 heating apparatus
160 thermocouple
170 inlet
180 outlet

What is claimed is:

1. A photocatalytic photoreactor comprising:
a first wall having an outer surface and an opposing inner surface, the inner surface defining an interior volume;
a second wall having an outer surface and an opposing inner surface, the second wall being spaced apart from the first wall such that the first wall and the second wall together define a reaction volume between the first wall outer surface and the second wall inner surface, wherein:
the second wall is at least partially transparent, and
the reaction volume is sized and shaped to receive a particulate photocatalyst therein such that incident light passing through the second wall from the second wall outer surface, to the second wall inner surface, and into the reaction volume penetrates a substantial portion of the reaction volume when a particulate photocatalyst is contained therein; and
an external light transmission apparatus, wherein:
the light transmission apparatus is positioned external to and at least partially around the second wall outer surface, and
the light transmission apparatus is adapted to transmit light through the second wall from the second wall outer surface, to the second wall inner surface, and into the reaction volume.

2. The photoreactor of claim 1, wherein the reaction volume has a thickness in a range of 0.5 mm to 10 mm.

3. The photoreactor of claim 2, wherein the reaction volume has an elongate structure with a length (L)/thickness (T) ratio of at least 10.

4. The photoreactor of claim 1, wherein the interior volume has a characteristic lateral dimension in a range of 5 mm to 100 mm.

5. The photoreactor of claim 1, wherein incident light passing through the second wall from the second wall outer surface, to the second wall inner surface, and into the reaction volume penetrates at least 50% of the reaction volume when a particulate photocatalyst is contained therein.

6. The photoreactor of claim 1, wherein:
the first wall is a first cylindrical tube;
the second wall is a second cylindrical tube coaxially aligned with the first cylindrical tube; and
the reaction volume is a circular annular volume between the first cylindrical tube and the second cylindrical tube.

7. The photoreactor of claim 1, wherein:
the first wall is a first rectangular duct;
the second wall is a second rectangular duct coaxially aligned with the first rectangular duct; and
the reaction volume is a rectangular annular volume between the first rectangular duct and the second rectangular duct.

8. The photoreactor of claim 1, wherein the light transmission apparatus comprises at least one light source, which is configured to transmit light around the circumference of the second wall and into the reaction volume.

9. The photoreactor of claim 1, wherein the light transmission apparatus comprises at least one light guide, which is configured to transmit received light around the circumference of the second wall and into the reaction volume.

10. The photoreactor of claim 1, wherein the light transmission apparatus comprises at least one light source and at least one light guide

11. The photoreactor of claim 1, wherein the interior volume defined by the first wall is an open interior volume adapted to receive one or more of (i) a heating apparatus adapted (or configured, positioned) to deliver thermal energy into the reaction volume through the first wall, (ii) a second light source adapted (or configured, positioned) to deliver light into the reaction volume through the first wall (when transparent), and (iii) a heat transfer liquid flowing through the open interior volume to heat or cool the reaction volume via heat transfer through the first wall.

12. The photoreactor of claim 1, further comprising a heating apparatus in the interior volume, the heating apparatus being adapted to deliver thermal energy into the reaction volume through the first wall.

13. The photoreactor of claim 1, wherein:
the first wall is at least partially transparent; and
the photoreactor further comprises a second light source in the interior volume, the second light source being adapted to deliver light into the reaction volume through the first wall.

14. The photoreactor of claim 1, wherein the second wall comprises quartz glass.

15. The photoreactor of claim 1, wherein the first wall comprises quartz glass.

16. The photoreactor of claim 1, wherein:
the first wall comprises an at least partially porous support and a selectively permeable membrane adjacent to the porous support; and/or the second wall comprises an at least partially porous support and a selectively permeable membrane adjacent to the porous support.

17. The photoreactor of claim 1, further comprising:
a particulate photocatalyst contained in the reaction volume.

18. The photoreactor of claim 17, wherein the particulate photocatalyst comprises a plasmonic metal selected from the group consisting of silver (Ag), gold (Au), copper (Cu), and combinations thereof.

19. The photoreactor of claim 17, wherein the particulate photocatalyst has a particle size in a range of 100 μm to 500 μm.

20. The photoreactor of claim 1, further comprising:
a particulate photocatalyst adhered (e.g., coated, bound, or otherwise immobilized) to at least one of the first wall outer surface and the second wall inner surface.

21. The photoreactor of claim 1, further comprising:
a thermocouple (or other temperature sensor) positioned within the reaction volume.

22. The photoreactor of claim 1, wherein the photoreactor comprises:
a fluid inlet in fluid communication with the reaction volume; and
a fluid outlet in fluid communication with the reaction volume;
wherein the fluid inlet and the fluid outlet are at different positions relative to the reaction volume such that fluid entering the photoreactor via the fluid inlet passes through the reaction volume before exiting the photoreactor via the fluid outlet.

23. A method for performing a photocatalytic reaction, the method comprising:
flowing a reactant through the reaction volume of the photoreactor according to claim 1, the photoreactor further comprising a particulate photocatalyst contained in the reaction volume; and
irradiating the particulate photocatalyst with the external light transmission apparatus while flowing the reactant through the reaction volume, thereby activating the particulate photocatalyst and catalyzing conversion of the reactant to a reaction product.

24. The method of claim 23, wherein the reactant comprises a gas-phase reactant stream.

25. The method of claim 23, wherein the reactant comprises a liquid-phase reactant stream.

26. The method of claim 23, wherein conversion of the reactant to a reaction product comprises performing a reaction selected from the group consisting of oxidation, partial oxidation, carbon dioxide hydrogenation, ammonia synthesis, hydrogenation, de-hydrogenation, and water-splitting.
